(19) United States
(12) Patent Application Publication
(10) Pub. No.: US 2012/0323655 A1
(43) Pub. Date: Dec. 20, 2012

(54) FUNDRAISING SYSTEM

(76) Inventor: Jeremy Tyler KENNEDY, Pendleton, OR (US)

(21) Appl. No.: 13/524,961

(22) Filed: Jun. 15, 2012

Related U.S. Application Data
(60) Provisional application No. 61/497,748, filed on Jun. 16, 2011.

(51) Int. Cl. G06Q 30/02

(52) U.S. Cl. 705/14.17

(57) ABSTRACT

Systems and methods for an organization to raise funds via contributions by a merchant are described. In one example system, a supply of unique codes is associated with a respective merchant for distribution by each respective merchant to respective consumers. The system includes an administrative entity. The administrative entity includes a code database module configured to store at least one of the unique codes and a respective association, and a contribution database module configured to document a contribution responsive to receipt of the at least one of the unique codes.

### CROSS REFERENCE TO RELATED APPLICATIONS

This application claims priority to and the benefit of U.S. provisional application No. 61/497,748 filed on Jun. 16, 2011 entitled “Fundraising System,” which is hereby incorporated by reference in its entirety for all purposes.

### BACKGROUND

1. Technical Field

The subject matter described herein relates to a fundraising and customer loyalty system whereby a merchant provides money to an organization or to a loyal customer in proportion to the amount of money spent by consumers at the merchant.

2. Description of the Related Art

Various attempts have been made to implement three-way fundraising systems between one or more organizations, one or more merchants, and one or more consumers. Many of these methods, however, require specialized merchant infrastructure or modifications to a merchant's existing Point of Sale (POS) systems. Currently, there are many different POS systems in use by various merchants, several of which are proprietary. Implementing a fundraising system by modifying POS systems may therefore be challenging due to both the number of different POS systems and the proprietary nature of several different POS systems.

The information included in this Background section of the specification, including any references cited herein and any description or discussion thereof, is included for technical reference purposes only and is not to be regarded subject matter by which the scope of the invention is to be bound.

### SUMMARY

The fundraising system disclosed herein allows merchants to sponsor organizations without needing to modify the merchants' specialized infrastructure or the merchants' existing POS systems. Specifically, an administrative entity may produce a supply of coupons, each coupon associated with a unique coupon code. The administrative entity may deliver a portion of the coupons to a particular merchant that has agreed to sponsor an organization, and record which coupons were sent to the merchant in connection with the sponsorship of a certain organization in a code database. In other embodiments, the administrative entity may provide coupons to a merchant where part of the unique code is a unique alpha-numeric code specific to that merchant. The merchant may distribute the coupons to consumers as consumers make purchases, in proportion to the purchases made. Once the consumer receives one or more coupons, he or she may submit the coupon back to the administrative entity by, for example, registering the coupon at a website on the Internet or mailing the coupon to the administrative entity to be manually entered. The administrative entity may then compare the submitted coupon codes against the code database, and record the appropriate contribution from the sponsoring merchant to the sponsored organization in a contribution database. Periodically, the administrative entity may send a statement to the merchants that have sponsored organizations and that have balances in the administrative entity's contribution database. After receiving these statements, the merchant(s) may send the contribution to the administrative entity for distribution to the sponsored organization(s). Alternatively, the merchant may place funds in an account with the administrative entity in advance (e.g. when the account is set up) that would be debited upon transfer of funds to the organization.

In one implementation, a system includes a supply of unique codes, each of the unique codes associated with a respective merchant for distribution by each respective merchant to respective consumers. The system also includes an administrative entity. The administrative entity includes a code database module configured to store at least one of the unique codes and a respective association, and a contribution database module configured to document a contribution responsive to receipt of the at least one of the unique codes.

In another implementation a method includes associating, utilizing at least one processor unit, each of a plurality of unique codes with a respective merchant. The method also includes providing a first merchant with a first of the plurality of unique codes for distribution to a consumer. The method also includes associating, utilizing the at least one processor unit, the first of the plurality of unique codes with the first merchant in a computer-implemented code database module. The method also includes receiving, utilizing the at least one processor unit, the first of the plurality of unique codes. The method also includes documenting, utilizing the at least one processor unit, a contribution based on the received unique code in a computer-implemented contribution database module.

In another implementation, a method includes receiving a plurality of unique codes from an administrative entity, each of the plurality of unique codes associated with a merchant. The method also includes providing a consumer with at least a first of the plurality of unique codes responsive to a purchase. The method also includes receiving a contribution statement from the administrative entity based on a contribution documented, utilizing at least one processor unit, in a computer-implemented contribution database module in response to the consumer providing the first of the plurality of unique codes to the administrative entity. The method also includes fulfilling the contribution in response to the received statement.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter. Other features, details, utilities, and advantages of the present invention will be apparent from the following more particular written description of various embodiments of the invention as further illustrated in the accompanying drawings and defined in the appended claims.

### BRIEF DESCRIPTION OF THE DRAWINGS

FIG. 1 is a schematic diagram of an implementation of a fundraising system as disclosed herein.

FIG. 2 is a schematic diagram of the fundraising system of FIG. 1 in operation after initial setup.

FIG. 3 is a flow diagram of the initial setup and operation of the fundraising system.

FIG. 4 is a schematic diagram of a coupon used in the fundraising system of FIGS. 1-3.

FIG. 5A is a screenshot of an exemplary administrative website for entering unique codes from coupons as shown in FIG. 4.

FIG. 5B is a screenshot of the administrative website of FIG. 5A after a unique coupon code has been entered.

FIG. 6 is a printed or displayed sponsorship statement page showing the amount due an organization by a merchant participating in the fundraising system of FIGS. 1-3.

FIG. 7 is a schematic diagram of an exemplary computer system that generally depicts the functionality of any computer used in implementations of this technology.

### DETAILED DESCRIPTION

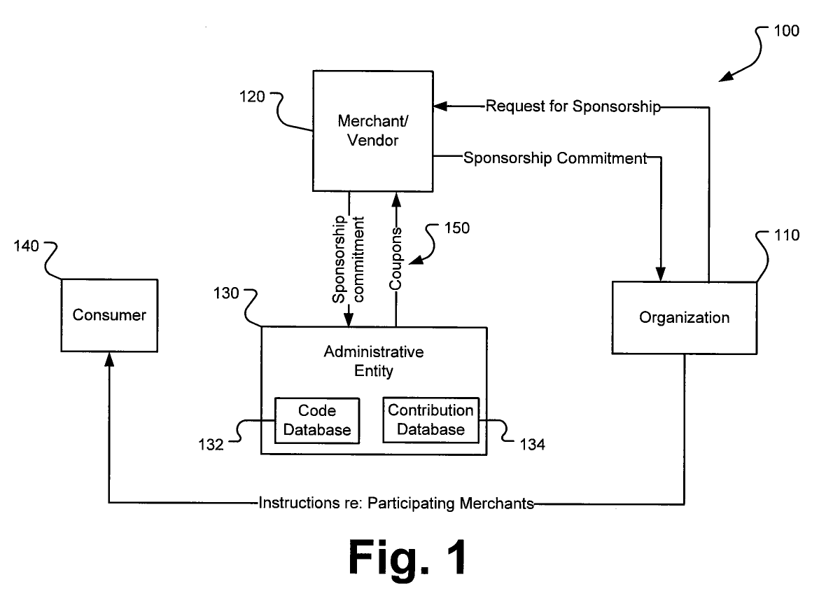

FIG. 1 show how some embodiments of a fundraising system 100 may be initially set up. An organization 110 may first request that a particular merchant 120 or vendor commit to sponsor or support the organization 110 through a fundraising process. The organization 110 may be a non-profit organization, a charity, a youth activity group such as scouting, a religious organization, a for-profit company, or even an individual in some cases. In some embodiments, the sponsorship or fundraiser may involve the merchant 120 contributing money, but in other embodiments, the merchant 120 may contribute goods or services. For a monetary or pecuniary sponsorship (i.e., a fundraiser), the merchant 120 may agree to donate a percentage of certain sales to the organization 110. For example, the merchant 120 may agree to donate fifty cents per twenty dollars of purchases by members of the organization 110. If the merchant 120 agrees to sponsor the organization 110, the merchant 120 may communicate the sponsorship commitment to the organization 110 and also to an administrative entity 130.

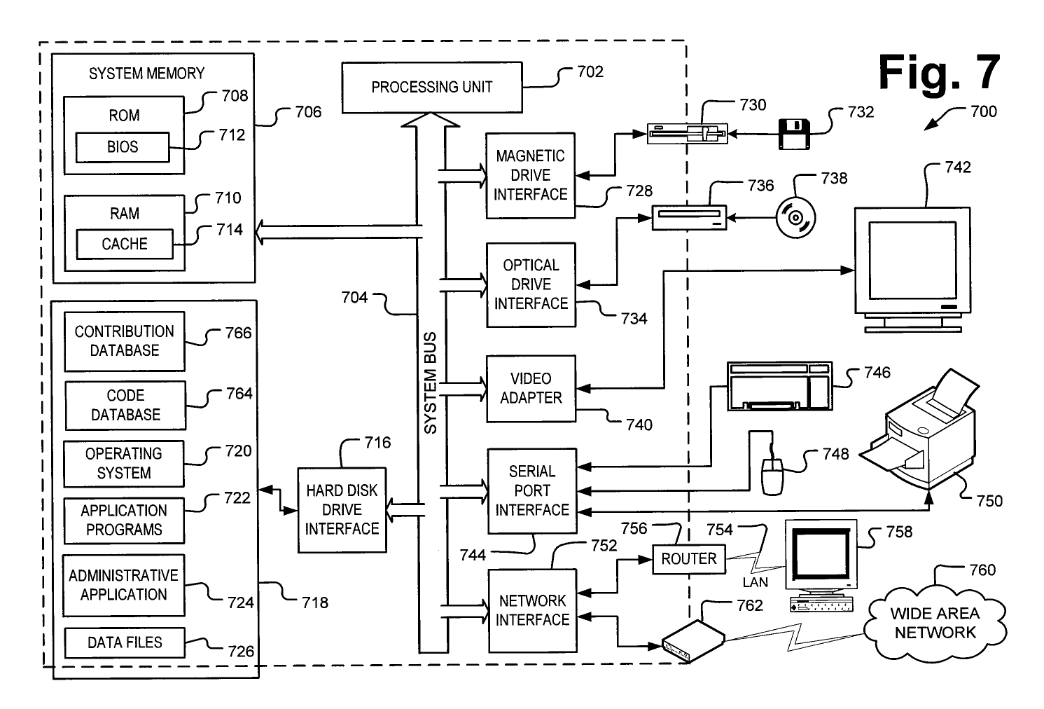

The administrative entity 130 may be implemented in a computer system, as described in more detail below with reference to FIG. 7, and may coordinate various sponsorship or fundraising agreements between one or more merchants 120 and one or more organizations 110. The administrative entity 130 may maintain a supply of coupons 150, each with a unique code assigned to it. The coupons 150 may be small pieces of paper, cardboard, or plastic, and each unique code may be printed on a single coupon 150. Upon receiving notice that a particular merchant 120 has agreed to sponsor one or more organizations 110, the administrative entity 130 may provide a plurality of coupons 150 to the merchant 120, and may record which coupons 150 were distributed to the merchant 120 in connection with the sponsorship of the organization 110 in a code database 132. The code database 132 allows the administrative entity 130 to keep track of which unique codes are associated with which merchants 120 and which organizations 110.

Once the organization 110 receives notice of the sponsorship commitment, the organization 110 may provide instructions to its members or supporters that a merchant 120 has agreed to support the organization 110. For example, if a certain grocery store has agreed to sponsor a girl scout troop, the girl scout troop leaders may inform the parents of the girl scouts that the grocery store is sponsoring the girl scout troop by committing to donate fifty cents per twenty dollars spent at the grocery store. The parents may then inform friends and relatives of the sponsorship. Knowing that the grocery store is sponsoring the girl scout troop may encourage the parents and other friends and relatives to patronize the sponsoring grocery store.

In some embodiments, a merchant 120 may commit to sponsoring more than one organization 110. To continue with the example given above, the grocery store may agree to sponsor the American Red Cross in addition to the local girl scout troop. In cases where the merchant sponsors more than one organization, the administrative entity 130 may note (based on the unique coupon codes) that the coupons were given to a particular merchant 120, and allow a consumer 140 (which may be an individual, a group of individuals, a business entity, etc.) to choose which of the supported organizations 110 should benefit from the donation resulting from the consumer 140 purchase (see below). Alternatively, the administrative entity may give two different sets of coupons 150 to the merchant 120 to hand out: one for the first organization 110, another for the second organization, and so on, and may record which set of coupons 150 given to the merchant 120 are associated with the different organizations 110.

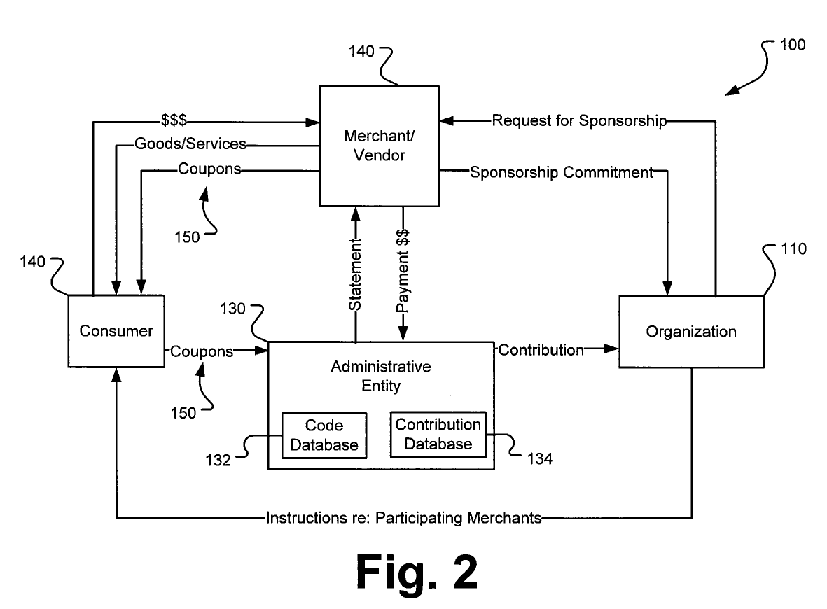

FIG. 2 shows how some embodiments of a sponsorship or fundraising system 100 may operate after the initial setup. A consumer 140 who has been informed that a certain merchant 120 is sponsoring an organization 110 may be inclined to patronize that merchant 120 because the consumer 140 is a member of the organization 110 or generally supports the organization's 110 goals. If the consumer 140 purchases goods or services from the merchant 120, he or she may notify the merchant 120 that he or she is a supporter of the organization 110 and request a sponsorship coupon 150. Alternatively, marketing materials (similar to stickers near a POS indicating which credit cards a merchant 120 accepts) may be used to indicate that the merchant 120 is part of a fundraising network. The merchant 120 may then provide one or more coupons 150 to the consumer 140 depending on the amount of money spent by the consumer 140. For example, if the sponsorship commitment was fifty cents per twenty dollars spent, with each coupon code representing a single fifty cent contribution, a consumer 140 who makes a one hundred dollar purchase may receive five coupons from the merchant 120.

After receiving one or more coupons 150 with a unique code, the consumer 140 may submit the unique code(s) to an administrative entity 130. In some embodiments, the administrative entity 130 may have a website on the Internet, while in other embodiments, the consumer 140 may physically send (e.g., mail) paper coupons 150 to the administrative entity 130. For the website embodiments, the consumer 140 may enter the code directly, or may first setup a user account. A user account may allow the consumer 140 to track the contributions or donations for which the consumer 140 is responsible. For example, the user account may allow the consumer 140 to see that he or she has submitted one hundred coupons 150 in support of an organization 110, which may represent fifty dollars worth of contributions from the merchant 120 to the organization 110 as a result of the consumer 140 patronizing the merchant 120.

Once the administrative entity 130 receives a coupon 150 or the unique code from a coupon 150, the administrative entity 130 may look up the unique code from the code database 132 to see which merchant 120 (and/or which organization 110) the code is associated with. If the coupon code is associated with only one organization 110 via the supporting merchant 120, the administrative entity 130 may record the contribution amount represented by the submitted coupon code in a contribution database 134. For example, if the coupon code represented a fifty cent contribution from a supermarket to a non-profit victim support center, the administrative entity 130 may make an entry in the contribution database 134 that the supermarket “owes” the non-profit center fifty cents.

If the coupon code is associated with multiple organizations 110 via the supporting merchant 120 (e.g., a supermarket supports a girl scout troop and a non-profit support center), the administrative entity 130 may allow the consumer 140 to choose the organization 110 to which the contribution should go to. For the website implementation, the website may provide a drop-down box that allows the consumer 140 to select the organization 110 that should benefit. Once the consumer 140 has specified which organization 110 should benefit from the merchant's 120 contribution, the administrative entity 130 may record that contribution as an entry in the contribution database 134.

Periodically (for example once a month, once a quarter, once a year, etc.), the administrative entity 130 may “bill” or send an accounting statement to each supporting merchant 120 reflecting the entries in the contribution database 134. For example, the administrative entity 130 may transmit an accounting statement to a supermarket merchant 120 stating that the total number of coupons 150 associated with the supermarket and submitted from consumers 140 for a particular organization 110 is one thousand, and that the supermarket therefore “owes” the organization 110, for example, five hundred dollars. The merchant 120 may send the money to the administrative entity 130 for distribution to the appropriate organization(s) 110, or alternatively, may contribute the money directly to the organization 110. In still other embodiments, and as described above, the merchant 120 may have placed funds in an account with the administrative entity 130 in advance, and the administrative entity 130 may therefore forward the money directly to the organization 110. In addition, the administrative entity 130 and merchant 120 may be able to view contributions owed, paid, etc. online.

Many variations for the fundraising or sponsorship system 100 described above are possible. For example, the unique coupon codes may be transmitted from the administrative entity 130 to the sponsoring merchant 120 electronically, and the merchant 120 may print the unique coupons code(s) on a separate coupon paper or on the receipt for a consumer's 140 purchase. In these cases, the “coupon” 150 may be considered to be an electronic coupon 150 because no physical paper coupons 150 were produced by the administrative entity 130 and provided to the merchant 120.

Another possible option is that a consumer 140 may be able to establish a personal account with an organization 110 whereby fees or costs that are personal to the consumer 140 may be paid for. For example, a boy scout troop planning a week long camping trip may impose a fifty dollar fee for each boy scout to cover food and other expenses related to the camping trip. If a department store has agreed to sponsor the boy scout troop, a particular boy scout (or his parents) may be able to establish a personal account via the administrative entity 130 to track donations from the department store specific to that boy scout, his parents, friends, and relatives who patronize the department store. If the department store has agreed to donate one dollar per twenty dollars spent, and the boy's family and friends spend a thousand dollars at the department store and submit the coupon codes associated with their purchases at the administrative entity 130 while specifying the boy scout's personal account, then the boy scout troop may be able to credit the department store's fifty dollar contribution to that boy scout's personal account for the camping trip.

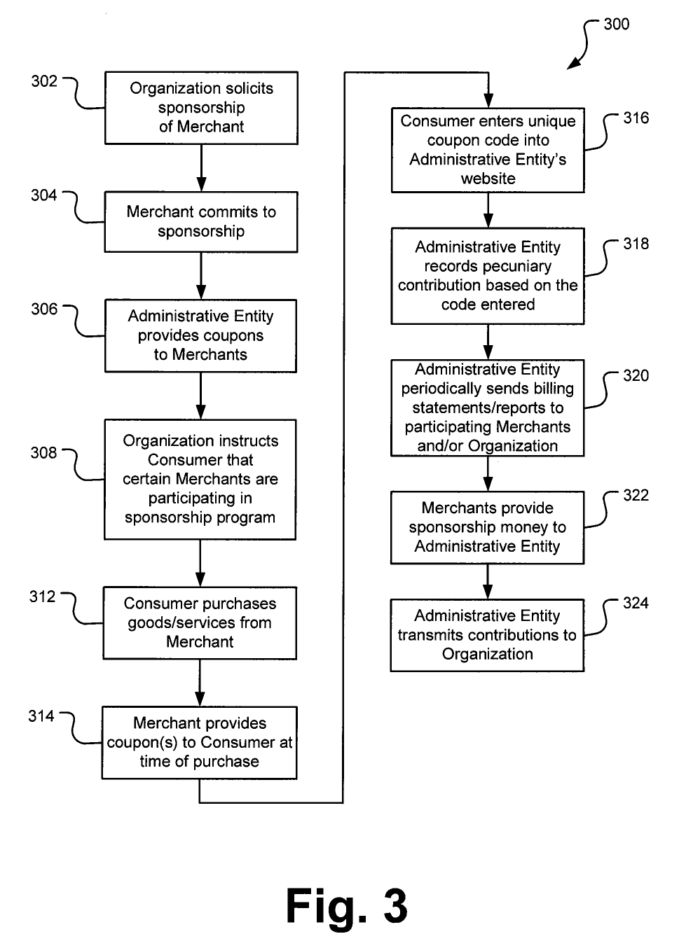

FIG. 3 is a flow diagram operations that may implement one embodiment of the fundraising system 100 described above. The operations shown in FIG. 3 may be implemented in the fundraising system 100 described above in connection with FIGS. 1 and 2. At operation 302, an organization may solicit a merchant to sponsor the organization. The sponsorship may be in the form of a fundraiser for the organization, or as described above, may involve the contribution of goods or services from the merchant to the organization. At operation 304, the merchant may commit to the sponsorship, and may communicate this commitment to the administrative entity and the organization that it is sponsoring. At operation 306, the administrative entity provides coupons associated with unique codes to the sponsoring merchant. As discussed above, these coupons may be physical pieces of paper, or may be electronically transferred from the administrative entity to the merchant.

Once the organization has received confirmation that the merchant will sponsor the organization, the organization may provide this information to its members and/or its supporters, and encourage them to purchase goods or services from the merchant in operation 308. The organization may further inform its members and/or supporters of the available coupons, and instruct them how to acquire and submit the unique codes associated with the coupons to the administrative entity 130. In this fashion, the organization “earns” the contribution from the merchant by driving consumers to the merchant. The merchant in turn benefits because of the increase in business and the opportunity to support, for example, a local non-profit group or charity.

At operation 312, a consumer may purchase goods or services from a merchant that has agreed to support an organization. The consumer may patronize the merchant as a result of being informed by the organization that a certain percentage of sales, or a certain fixed amount of monetary or other contribution, will be given by the merchant to the organization in response to consumers making purchases from the merchant. At the point-of-sale transaction in operation 312, the consumer may notify a clerk of the merchant that he or she is a member or supporter of an organization that is being sponsored by the merchant, or alternatively, the clerk of the merchant may solicit from the consumer whether he or she is part of one or more organizations being sponsored by the merchant. At operation 314, the merchant may provide one or more coupons to the consumer depending on how much the consumer purchases and the specifics of the sponsorship agreement between the merchant and the organization. The coupons may be physical pieces of paper, etc. or, as discussed above, may be printed on the consumer's receipt. In still other embodiments, the one or more coupons, with the associated unique code(s) may be provided to the consumer in still other ways, such as by email, wireless RFID transmission to a consumer card, Bluetooth transmission to a personal electronic device (e.g., a smart phone), text message, and so forth. Note that the fundraising or sponsorship program described herein does not necessarily depend on the method of payment (e.g., credit card, cash, check, etc.) tendered by the consumer or the merchant's point-of-sale system.

Once the consumer has received one or more coupons, he or she may submit the unique coupon code(s) at the administrative entity site. In operation 316, a consumer uses a web browser connected to the Internet to access the administrative entity's website. The administrative entity's website may prompt the consumer to register or otherwise set up an account with the administrative entity in some embodiments, but in other embodiments, the consumer need not create an online account with the administrative entity. Once the consumer has entered the unique coupon code(s) in operation 316, the administrative entity may determine which respective merchant and/or organization the unique coupon code(s) are associated with. In the event that the code entered was uniquely associated with one merchant and one organization, the administrative entity may record a pecuniary contribution based on the code entered. In the event that the coupon code was associated with a merchant and two or more organizations, the administrative website may prompt the consumer entering the code for a preference of which of the sponsored organizations the consumer wishes the associated contribution to pass. In some embodiments, there may be a default organization if the consumer does not select one or if the consumer mails in the unique coupon code without specifying which of a plurality of charities the contribution should go towards. For example, the default organization may be a preferred charity designated by the merchant, or it may be the organization that has received the least (or the most) amount of contributions up until that time. In any event, the administrative entity records the appropriate contribution, and may prompt the consumer for entry of any additional unique coupon codes.

Periodically, the administrative entity may send billing statements or reports to participating merchants in operation 320 reflecting the accrued contributions recorded in the administrative entity's contribution database. In addition to providing the total contribution amount that the merchant “owes” to the organization(s), a statement may include various statistics, for example, the statement may identify a top purchasing consumer. If the merchant sponsors multiple organizations, the statement may provide statistics for each of the organization sponsorships individually, and/or as a group. In some embodiments, in addition to sending a statement to a sponsoring merchant(s), the administrative entity may send one or more statements to a sponsored organization(s). The statement transmitted to a sponsored organization may also include data such as consumers who helped obtain the most contributions from the merchant, and may also include data from multiple sponsoring merchants for that organization. The billing statements, reports, and other data may be available online at a website maintained by the administrative entity, and may be available to the merchants, organizations, and/or consumers, although the level of access to that information may vary among the different groups. Alternatively, in some other embodiments, the statements, reports, and other data may be provided by the administrative entity on paper to the various merchants, organizations, and/or consumers. In either case, the administrative entity may sell advertising space on the webpage or on the paper reports to the merchants or other third parties.

In connection with the statement(s) sent to the merchants, the merchants may also use this system to reward a consumer for frequent business—each time a consumer purchases goods or services at merchant, he/she registers the coupon online, and at the end of the contest/promotion, the merchant may give prize to the most frequent shopper, to a randomly chosen winner, etc.

Upon receipt of a statement, the merchant may remit the contribution amounts owed as reflected on the statements to the administrative entity as indicated in operation 322. The remittance by the merchant may be with respect to a single charitable organization or, if the merchant is sponsoring multiple organizations, the remittance may be a lump sum payment covering amounts due to several organizations. As indicated in operation 324, upon receipt of funds from the merchant, the administrative entity may then distribute the funds to one or more charitable organizations based upon the unique coupon codes redeemed by consumers with the administrative entity. In an alternate embodiment, upon receipt of a statement from the administrative entity, the merchant could make a direct payment of contributions owed directly to the charitable organization indicated in the statement. In another alternate embodiment, merchants may have placed funds with the administrative entity in advance, and the administrative entity may automatically forward the appropriate funds to the organizations in connection with providing statements or reports to the merchants in operation 320, thereby skipping operation 322.

The operations shown in FIG. 3 may also be generally adaptable to a consumer loyalty system. For example, a merchant who does not have a loyalty system built-in to its POS system (such as a small business) may want to reward loyal or repeat consumers in a manner similar to how the merchant may sponsor an organization. In other words, the merchant may encourage consumers to patronize their store by promising an incentive for the consumer himself or herself, rather than promising a payment to a third-party organization. Such a loyalty system may operate in much the same manner as the fundraising or sponsorship system described in connection with FIGS. 1 through 3, except that the “organization” receiving the contribution would be the same entity as the “consumer.”

Specifically, a merchant may set up an account with the administrative entity, and the administrative entity would in turn provide loyalty coupons to the merchant. As a consumer purchase goods and services from the merchant, the merchant may give the consumer loyalty coupons (or other forms of unique codes). For example, the merchant may give a consumer a loyalty coupon for every fifty dollars spent at the merchant. The consumer may then enter the unique code associated with the coupon into the administrative entity's website, and the administrative entity may then periodically send statements or bills to the merchant regarding the consumer's entered coupon codes. Such reports may aid the merchant in marketing or other business planning because of the customer data contained therein. After or in conjunction with providing the statements or bills, the administrative entity may forward any payment or other loyalty rewards received from the merchant (which may, in some cases, have been provided to the administrative entity in advance) to the loyal consumer, or instruct the merchant regarding how much the merchant “owes” the consumer.

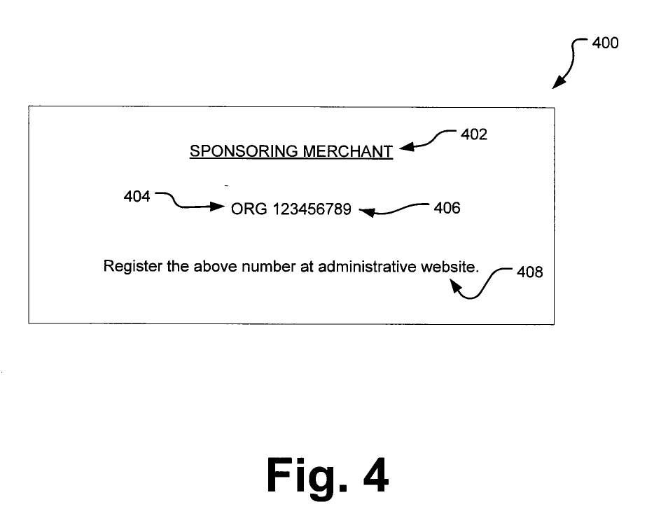

FIG. 4 shows one embodiment of a coupon 400 that may be used in the fundraising or sponsorship system 100 described in connection with FIGS. 1 through 3. The coupon 400 may include one or more of, for example, an identification of the sponsoring merchant 402, the sponsored organization's name 404, a unique code 406, a website 408 or mailing address to submit the code to an administrative entity, and so forth. In some embodiments. However, the coupon 400 may only have a unique code 406 or, in other embodiments, the “coupon” 400 may be printed as part of the receipt resulting from the consumer's transaction with the merchant, or may be sent to the consumer by email, text message, etc.

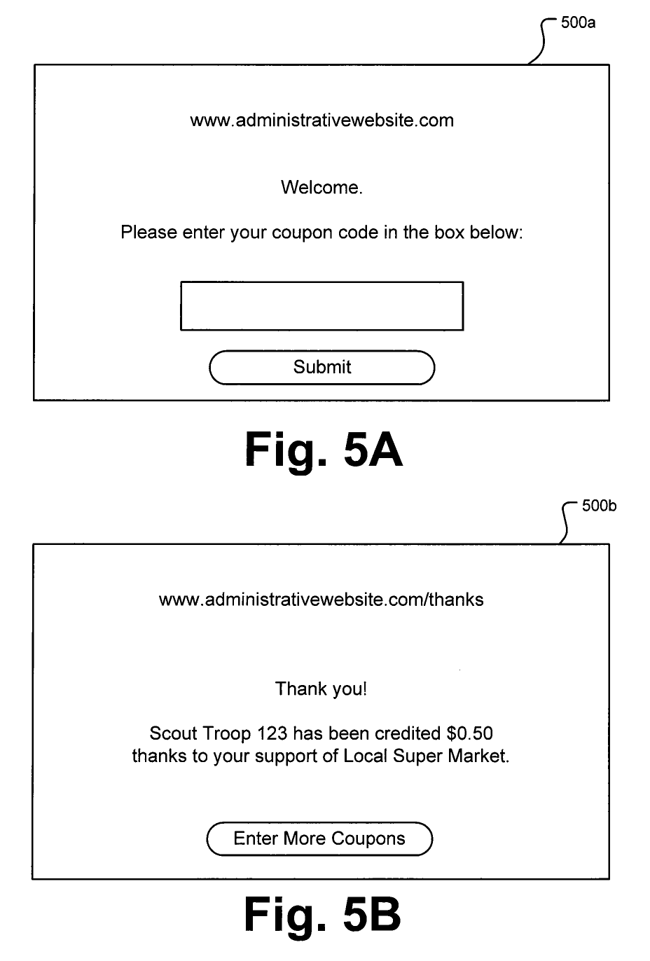

FIGS. 5A and 5B show exemplary screenshots 500a, 500b of one embodiment of a website that implements the fundraising or sponsorship system 100 described above. In FIG. 5A, the website prompts the consumer for the unique coupon code. In FIG. 5B, the website confirms that the contribution associated with the unique code entered has been recorded in the administrative entity's contribution database.

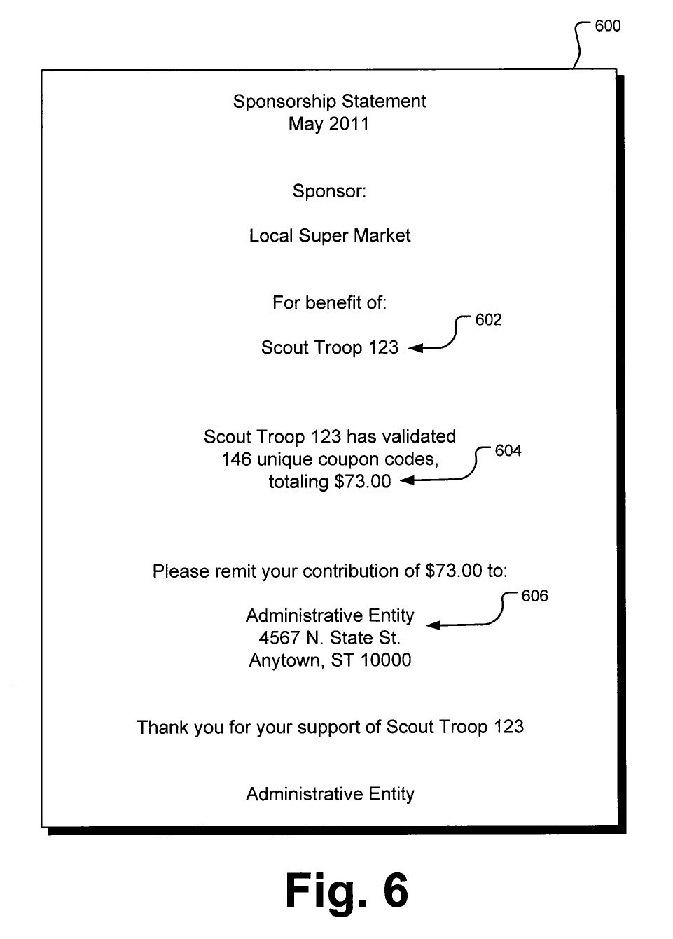

FIG. 6 shows one embodiment of an accounting statement 600 or report sent by the administrative entity to a sponsoring merchant for a one-month period. The statement notes the sponsored organization 602, the amount of the contribution 604 based on the unique codes submitted to the administrative entity site and recorded in the administrative entity's contribution database, and an address 606 of the administrative agency to which the merchant should mail the contribution. Alternatively, an automatic funds transfer arrangement may be established between the administrative entity and a merchant bank account for automatic remittance of contributions owed on a regular basis. As discussed above, the statement may include much more detail than that shown in FIG. 7. As another alternative, the merchant may have pre-placed funds with the administrative entity, which then automatically forwards the money to various organizations.

An exemplary computer system 700 for implementing some of the functions described above is depicted in FIG. 7. The computer system 700 of a merchant's POS system or of a consumer's computer (by which the consumer submits unique coupon codes to the administrative entity's website) may be a personal computer (PC), a workstation, a notebook or portable computer, a tablet PC, a handheld media player (e.g., an MP3 player), a smart phone device, a video gaming device, or a set top box, with internal processing and memory components as well as interface components for connection with external input, output, storage, network, and other types of peripheral and computer devices. The computer system 700 of the administrative entity (including, in some embodiments, the website of the administrative entity) may be in the form of any of a server computer, a mainframe computer, a distributed computer, an Internet appliance, a cloud-based device, or other computer devices, or combinations thereof. In each case, the computer systems may have similar internal processing and memory components as well as interface components for connection with external input, output, storage, network, and other types of peripheral devices. Internal components of the computer system in FIG. 7 are shown within the dashed line and external components are shown outside of the dashed line. Components that may be internal or external are shown straddling the dashed line.

The computer system 700 may include a processor 702 and a system memory 706 connected by a system bus 704 that also operatively couples various system components. There may be one or more processors 702, e.g., a single central processing unit (CPU), or a plurality of processing units, commonly referred to as a parallel processing environment (for example, a dual-core, quad-core, or other multi-core processing device). The system bus 704 may be any of several types of bus structures including a memory bus or memory controller, a peripheral bus, a switched-fabric, point-to-point connection, and a local bus using any of a variety of bus architectures. The system memory 706 includes read only memory (ROM) 708 and random access memory (RAM) 710. A basic input/output system (BIOS) 712, containing the basic routines that help to transfer information between elements within the computer system 700, such as during start-up, is stored in ROM 708. A cache 714 may be set aside in RAM 710 to provide a high speed memory store for frequently accessed data.

A hard disk drive interface 716 may be connected with the system bus 704 to provide read and write access to a data storage device, e.g., a hard disk drive 718, for nonvolatile storage of applications, files, and data. A number of program modules and other data may be stored on the hard disk 718, including an operating system 720, one or more application programs 722, and data files 726. In an exemplary implementation, the hard disk drive 718 may store the administrative entity application 724 for managing the fundraising system, the code database 764 for storage of the unique coupon codes and an associated merchant (and possibly an associated organization), and/or the contribution database 766 for storing contribution information according to the processes described herein above. Note that the hard disk drive 718 may be either an internal component or an external component of the computer system 700 as indicated by the hard disk drive 718 straddling the dashed line in FIG. 7. In some configurations, there may be both an internal and an external hard disk drive 718.

The computer system 700 may further include a magnetic disk 730 or a solid state memory (e.g., FLASH) for reading from or writing to a removable magnetic disk 732, tape, flash drive, or other magnetic media. The magnetic disk drive 730 may be connected with the system bus 704 via a magnetic drive interface 728 to provide read and write access to the magnetic drive 730 initiated by other components or applications within the computer system 700. The magnetic drive 730 and the associated computer-readable media may be used to provide nonvolatile storage of computer-readable instructions, data structures, program modules, and other data for the computer system 700.

The computer system 700 may additionally include an optical disk drive 736 for reading from or writing to a removable optical disk 738 such as a CD ROM or other optical media. The optical disk drive 736 may be connected with the system bus 704 via an optical drive interface 734 to provide read and write access to the optical disk drive 736 initiated by other components or applications within the computer system 700. The optical disk drive 730 and the associated computer-readable optical media may be used to provide nonvolatile storage of computer-readable instructions, data structures, program modules, and other data for the computer system 700.

A display device 742, e.g., a monitor, a television, or a projector, or other type of presentation device may also be connected to the system bus 704 via an interface, such as a video adapter 740 or video card. Similarly, audio devices, for example, external speakers or a microphone (not shown), may be connected to the system bus 704 through an audio card or other audio interface (not shown).

In addition to the monitor 742, the computer system 700 may include other peripheral input and output devices, which are often connected to the processor 702 and memory 706 through the serial port interface 744 that is coupled to the system bus 706. Input and output devices may also or alternately be connected with the system bus 704 by other interfaces, for example, a universal serial bus (USB), an IEEE 1394 interface (“Firewire”), a parallel port, or a game port. A user may enter commands and information into the computer system 700 through various input devices including, for example, a keyboard 746 and pointing device 748, for example, a mouse. Other input devices (not shown) may include, for example, a joystick, a game pad, a tablet, a touch screen device, a satellite dish, a scanner, a facsimile machine, a microphone, a digital camera, and a digital video camera.

Output devices may include a printer 750 and one or more loudspeakers 770 for presenting the audio performance of the sender. Other output devices (not shown) may include, for example, a plotter, a photocopier, a photo printer, a facsimile machine, and a press. In some implementations, several of these input and output devices may be combined into single devices, for example, a printer/scanner/fax/photocopier. It should also be appreciated that other types of computer-readable media and associated drives for storing data, for example, magnetic cassettes or flash memory drives, may be accessed by the computer system 700 via the serial port interface 744 (e.g., USB) or similar port interface.

The computer system 700 may operate in a networked environment using logical connections through a network interface 752 coupled with the system bus 704 to communicate with one or more remote devices. The logical connections depicted in FIG. 7 include a local-area network (LAN) 754 and a wide-area network (WAN) 760. Such networking environments are commonplace in home networks, office networks, enterprise-wide computer networks, and intranets. These logical connections may be achieved by a communication device coupled to or integral with the computer system 700. As depicted in FIG. 7, the LAN 754 may use a router 756 or hub, either wired or wireless, internal or external, to connect with remote devices, e.g., a remote computer 758, similarly connected on the LAN 754. The remote computer 758 may be another personal computer, a server, a client, a peer device, or other common network node, and typically includes many or all of the elements described above relative to the computer system 700.

To connect with a WAN 760, the computer system 700 typically includes a modem 762 for establishing communications over the WAN 760. Typically the WAN 760 may be the Internet. However, in some instances the WAN 760 may be a large private network spread among multiple locations, or a virtual private network (VPN). The modem 762 may be a telephone modem, a high speed modem (e.g., a digital subscriber line (DSL) modem), a cable modem, or similar type of communications device. The modem 762, which may be internal or external, is connected to the system bus 718 via the network interface 752. In alternate embodiments the modem 762 may be connected via the serial port interface 744. It should be appreciated that the network connections shown are exemplary and other means of and communications devices for establishing a network communications link between the computer system and other devices or networks may be used.

The technology described herein may be implemented as logical operations and/or modules in one or more systems, such as in at least one processor unit (e.g., processing unit 702, or other computer hardware). The logical operations may be implemented as a sequence of processor-implemented steps executing in one or more computer systems and as interconnected machine or circuit modules within one or more computer systems. Likewise, the descriptions of various component modules may be provided in terms of operations executed or effected by the modules. The resulting implementation is a matter of choice, dependent on the performance requirements of the underlying system implementing the described technology. Accordingly, the logical operations making up the embodiments of the technology described herein are referred to variously as operations, steps, objects, or modules. Furthermore, it should be understood that logical operations may be performed in any order, unless explicitly claimed otherwise or a specific order is inherently necessitated by the claim language. In some implementations, articles of manufacture are provided as computer program products. In one implementation, a computer program product is provided as a computer-readable medium storing an encoded computer program executable by a computer system.

The above specification, examples and data provide a complete description of the structure and use of exemplary embodiments of the invention as claimed below. Although various embodiments have been described above with a certain degree of particularity, or with reference to one or more individual embodiments, those skilled in the art could make numerous alterations to the disclosed embodiments without departing from the spirit or scope of the claimed invention. Other embodiments are therefore contemplated. It is intended that all matter contained in the above description and shown in the accompanying drawings shall be interpreted as illustrative only of particular embodiments and not limiting. Changes in detail or structure may be made without departing from the basic elements of the invention as defined in the following claims.

What is claimed is:

1. A system comprising
a supply of unique codes, each of the unique codes associated with a respective merchant for distribution by each respective merchant to respective consumers; and
an administrative entity comprising
a code database module configured to store at least one of the unique codes and a respective association; and
a contribution database module configured to document a contribution responsive to receipt of the at least one of the unique codes.

2. The system of claim 1, wherein each of the plurality of unique codes is also associated with a respective organization.

3. The system of claim 1, wherein the administrative entity includes an internet accessible interface.

4. The system of claim 1, wherein the administrative entity is configured to transmit a contribution statement to a first merchant based on the contribution database.

5. The system of claim 1, wherein the contribution includes a pecuniary contribution.

6. The system of claim 1, wherein the administrative entity further comprises a personal account module configured to track contributions specific to a personal account.

7. The system of claim 1, wherein each of the unique codes is printed on a coupon.

8. A method, comprising:
associating, utilizing at least one processor unit, each of a plurality of unique codes with a respective merchant;
providing a first merchant with a first of the plurality of unique codes for distribution to a consumer;
associating, utilizing the at least one processor unit, the first of the plurality of unique codes with the first merchant in a computer-implemented code database module;
receiving, utilizing the at least one processor unit, the first of the plurality of unique codes; and
documenting, utilizing the at least one processor unit, a contribution based on the received unique code in a computer-implemented contribution database module.

9. The method of claim 8, wherein each of the plurality of unique codes is also associated with a respective organization.

10. The method of claim 9 further comprising associating, utilizing the at least one processor unit, the first of the plurality of unique codes with its respective organization association in the computer-implemented code database module.

11. The method of claim 10 further comprising determining, utilizing the at least one processor element, which respective merchant and/or which respective organization is associated with the at first of the plurality of unique codes.

12. The method of claim 10, wherein the associating the first of the plurality of unique codes with its respective organization operation comprises storing data indicative of said operation in a tangible, computer-readable medium.

13. The method of claim 8, wherein a second of the plurality of unique codes is associated with a second organization.

14. The method of claim 13 further comprising receiving, utilizing the at least one processor unit, an indication of a desired organization to which a received unique code should be attributed to.

15. The method of claim 8 further comprising receiving the contribution from the first merchant and providing at least a portion of the contribution to an organization.

16. The method of claim 8, wherein the first of the plurality of unique codes is received via an internet accessible interface.

17. A method comprising
receiving a plurality of unique codes from an administrative entity, each of the plurality of unique codes associated with a merchant;
providing a consumer with at least a first of the plurality of unique codes responsive to a purchase;
receiving a contribution statement from the administrative entity based on a contribution documented, utilizing at least one processor unit, in a computer-implemented contribution database module in response to the consumer providing the first of the plurality of unique codes to the administrative entity; and
fulfilling the contribution in response to the received statement.

18. The method of claim 17, wherein the providing operation comprises printing the first of the plurality of unique codes on a receipt.

19. The method of claim 17 further comprising fulfilling the contribution by directly submitting the contribution to an organization.

20. The method of claim 17, wherein
the plurality of unique codes comprises a first plurality of unique codes; and
the first plurality of unique codes is associated with a first organization; and
the method further comprises
receiving, from the administrative entity, a second plurality of unique codes associated with a second organization.
